(19) United States
(12) Patent Application Publication
(10) Pub. No.: US 2020/0079577 A1
(43) Pub. Date: Mar. 12, 2020

(54) URINE-ABSORBING SHEETS AND DISPENSING DEVICES

(71) Applicant: Jeanne Ngo, Alhambra, CA (US)

(72) Inventor: Jeanne Ngo, Alhambra, CA (US)

(21) Appl. No.: 16/125,218

(22) Filed: Sep. 7, 2018

(51) Int. Cl. B65D 83/08; A01K 1/015; A47K 10/32

(52) U.S. Cl. CPC B65D 83/0835; A47K 2010/3233; A47K 10/32; A01K 1/0157

(57) ABSTRACT

Examples herein are related to urine-absorbing sheets and a dispensing device. One example provides a continuous urine-absorbing sheet separable into individual sheet sections and positioned in a layered arrangement, the urine-absorbing sheet being separable at predefined locations in the sheet, and the urine-absorbing sheet comprising an absorbent layer and a liner layer.

### BACKGROUND

Pet animals may be housetrained or potty-trained in many different ways. For example, pet owners may utilize litter boxes, training crates, urine pads, pet potties, and other potty-training equipment for use indoors.

### SUMMARY

Examples of urine-absorbing sheets and dispensing devices for said sheets are disclosed. One example provides a continuous urine-absorbing sheet separable into individual sheet sections and positioned in a layered arrangement, the urine-absorbing sheet being separable at predefined locations in the sheet, and the urine-absorbing sheet comprising an absorbent layer and a liner layer.

Another example provides a dispensing container comprising an enclosure configured to house a layered arrangement of a continuous, urine-absorbing sheet, the enclosure having an aperture through which the sheet may be pulled, and one or more support structures for mounting the container to an inside of a kennel to position the aperture in a generally vertical orientation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows an example use scenario for urine-absorbing sheets.

FIG. 2 shows another example use scenario for urine-absorbing sheets.

FIG. 3A shows a side view of an example dispensing device for urine-absorbing sheets.

FIG. 3B shows a top view of the dispensing device of FIG. 3A.

FIG. 4 shows an example layered arrangement for a urine-absorbing sheet in the form of a roll.

FIG. 5 shows another example layered arrangement for a urine-absorbing sheet in the form of a stack.

FIG. 6 shows an exploded view of example layers within a urine-absorbing sheet section.

FIG. 7 shows an example urine-absorbing sheet section having slits and an adhesive backing.

FIG. 8 shows an example manner in which the slits and adhesive backing of a urine-absorbing sheet may be used to attach the sheet to a cage wall.

### DETAILED DESCRIPTION

For some pet owners, it may be challenging to housetrain their pets. Some pet owners may purchase urine pads or other absorbent equipment to place around the house at locations of likely urination. However, conventional urine pads are designed to be placed horizontally flat, such as on the floor, and may not effectively address the problem of spraying. Other potty-training structures, such as indoor litter boxes, may be prone to buildup of odors, may be a hassle to clean, and may not effectively attract certain animals to use them, such as dogs. Such training equipment also fails to address the problem of accidents, as they cannot protect other areas and household items not within the vicinity of the pad/litter box. Urine pads, litter boxes, and other existing potty-training equipment may also be easily damaged or destroyed by pet animals.

Accordingly, examples are disclosed herein that relate to urine-absorbing pads or sheets configured to address such problems, and to containing dispensing devices that may help pet owners to more easily protect and guard their home and furniture from urine damage. The disclosed example dispensing devices may house and protect urine-absorbing sheets inside of an enclosure, which may help prevent pets from tearing or otherwise damaging the sheets, while having an opening in the enclosure through which the sheets may be pulled out. Such a dispensing device may have a base to allow the device to be placed as a standalone object without being easily knocked over, and/or may have support structures configured to secure the device to a structure, such as to the side of a cage/kennel. Further, the urine-absorbing sheets may include an adhesive backing that allow the sheets to be attached to objects in various orientations. Thus, the dispensing devices may allow urine-absorbing sheets to be easily dispensed and attached onto or around desired structures, such as cages/kennels, pet carriers, furniture, walls, etc. to protect those items in case of accidents. As such, the dispensing devices and urine-absorbing sheets may be especially helpful for pet owners who have not yet potty-trained their dogs or have been unsuccessful in potty-training their dogs.

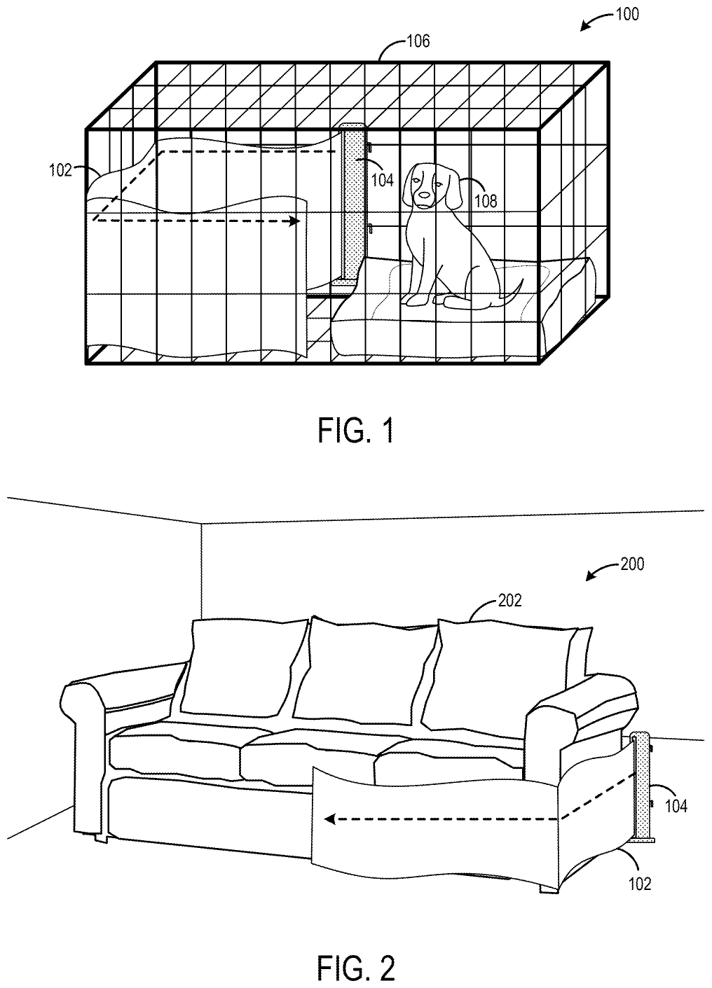

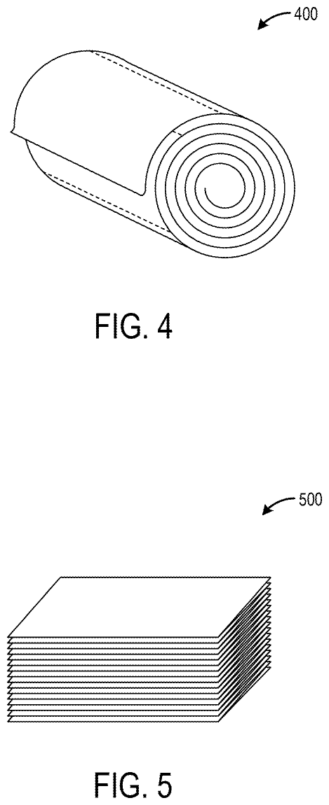

FIG. 1 shows an example use scenario 100 for a urine-absorbing sheet 102 and a dispensing device 104 housing the urine-absorbing sheet 102. The dispensing device 104 is mountable to the side wall of a dog kennel 106. In this example, the dispensing device 104 is positioned upright in a generally vertical direction to allow the urine-absorbing sheet 102 to be pulled out to cover the side walls of the dog kennel 106. The urine-absorbing sheet 102 may take the form of a continuous sheet that is separable into individual sheet sections, such as being perforated at predefined locations, allowing each sheet section to be torn off. As will be described in more detail below with regard to FIGS. 4 and 5, the urine-absorbing sheet 102 may be arranged inside the dispensing device 104 in a layered manner, such as in a roll or a stack. Each sheet section of the urine-absorbing sheet 102 may optionally include an adhesive backing that allows the sheet sections to adhere to the bars of the dog kennel 106.

FIG. 2 shows another example use scenario 200 for the urine-absorbing sheets 102 housed in dispensing device 104. In this example, the dispensing device 104 is placed upright on the floor, such that the urine-absorbing sheet 102 may be pulled out and wrapped around the base of furniture item 202. The urine-absorbing sheet 102 may be similarly wrapped around or pulled over any suitable objects, such as walls, floors, other furniture pieces, cages, kennels, carriers, crates, dog houses etc.

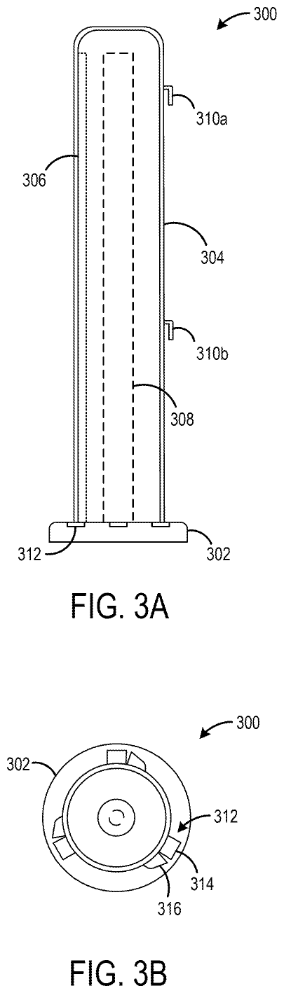

FIG. 3A shows a side view of an example dispensing device 300 for urine-absorbing sheets, and FIG. 3B shows a top view of the dispensing device 300. Dispensing device 300 includes a base 302, which allows the dispensing device 300 to stand upright. The base 302 may be relatively heavy compared to the rest of the body, such that the dispensing device 300 may not be easily knocked over when standing and containing urine-absorbing sheets. As an example, the base 302 may be formed from a metal, rust-resistant material, such as aluminum, galvanized steel, stainless steel, brass, and/or other suitable metals or alloys. As another example, the base 302 may be formed from a plastic material that is weighted, e.g. a hollow base that can be filled with water or other weighted objects. The base 302 may be weighted in any other suitable manner.

Dispensing device 300 further includes a cylindrical removable covering 304 that may be attached to the base 302 to form an enclosure. The removable covering 304 may be formed from a sufficiently hard material that may prevent an animal from puncturing, scratching, denting, or otherwise damaging the removable covering 304. The removable covering 304 may be formed from a material that is lighter in weight than the base 302. For example, if the base 302 is made from a metal material, the removable covering 304 may be made from a plastic material. In other examples, the removable covering 304 may be formed from a same material as the base 302, in which case the base 302 may be of a sufficiently large size to outweigh the rest of the body, or may be suitably weighted as mentioned above. The removable covering 304 has an aperture 306 through which a contained urine-absorbing sheet may be pulled. Although shown here as a slit-shaped aperture running along a length of the removable covering 304, the aperture may take any other suitable shape. In some examples, the aperture may take an L-shape, to facilitate pulling out urine-absorbing sheet sections vertically as well as horizontally.

The removable covering 304 may be configured to attach to the base 302 via locking features 312 on the base 302. The dispensing device 300 shown has three such locking features 312, as an example. The locking features 312 include a notch 314 and a protruding structure 316 configured to receive corresponding features on the removable covering 304 to secure the removable covering 304 to the base 302. Any other suitable securing locking mechanism may be utilized, such as latches, magnets, slots, snapping structures, etc. The removable covering 304 may protect the urine-absorbing sheet, while still allowing a user to remove the removable covering 304 to access the interior, replace the urine-absorbing sheet, and clean the dispensing device.

The dispensing device 300 further includes a center rod 308 configured to support a roll of a continuous, urine-absorbing sheet. This allows the sheet roll to rotate as the sheet is dispensed, in this case along a rotational axis aligned generally in a vertical direction. In some examples, the center rod 308 may be omitted.

The dispensing device 300 further includes support structures 310a and 310b configured to suspend the container, e.g. from the wall of a kennel or cage. Although shown here as hooks, any other attachment or support structure may be utilized, such as clips, magnets, ties, locks, suction cups, etc. Further, the dispensing device 300 may be configured to be hung in a generally vertical direction or a generally horizontal direction. The support structures 310a, 310b may allow the dispensing device 300 to easily transition between standing upright on the floor or being suspended.

FIG. 4 shows an example layered arrangement for a urine-absorbing sheet in the form of a roll 400. Roll 400 includes perforations at regular intervals at predefined locations throughout the length of the roll 400, as shown by dotted lines. Roll 400 may remain hollow in the center to be received by the center rod 308 of dispensing device 300, for example. FIG. 5 shows another embodiment of a layered arrangement for a urine-absorbing sheet in the form of a zig-zag stack 500. Stack 500 may include perforations at each of the folds, for example, or at any other suitable locations throughout the stack 500. It will be understood that urine-absorbing sheet(s) may be arranged in a rolled, zig-zag, stacked, folded, or otherwise suitably layered arrangement.

As mentioned above, for each of roll 400 and stack 500, the continuous urine-absorbing sheet may be perforated at predefined locations regularly along the length of the sheet, such that the sheet is separable into individual sheet sections. In other examples, the sheet may be partitioned in any other suitable manner, or the sheet may not have perforations but may be able to be torn or cut however desired. Alternatively, rather than a continuous urine-absorbing sheet, a dispensing device may house preformed sheet sections.

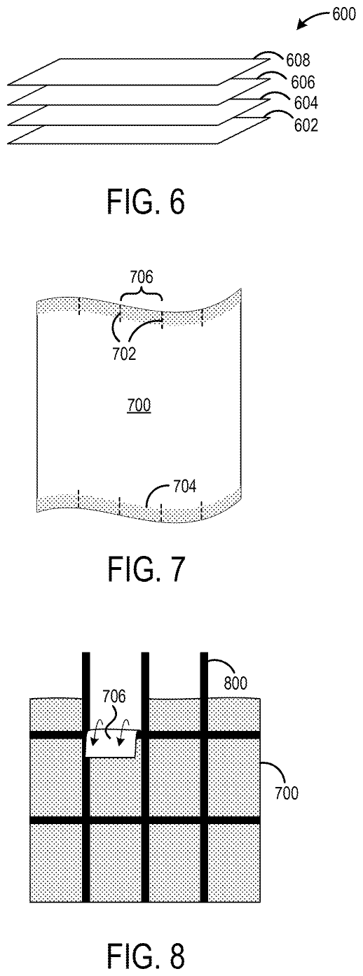

FIG. 6 shows an exploded view of example layers within one urine-absorbing sheet section 600. Starting from the bottom, the urine-absorbing sheet section 600 includes a bottom liner layer 602 that may protect the floor or surrounding environment from liquid absorbed by the sheet. The liner layer 602 may be of a plastic material to help protect the sheet from leaking, for example. Next, the urine-absorbing sheet section 600 includes one or more absorbent layers, such as a bottom absorbent layer 604 and a top absorbent layer 606. Additional absorbent layers may also be included. The absorbent layers may include absorbent polymers, tissue, fabric, or other suitably absorbent materials. The urine-absorbing sheet section 600 also includes top layer 608, which may act as a protective layer. In some examples, the top layer 608 may be tear-resistant or include an attractant to attract pet animals to the sheet. All layers 602 to 608 may be bound at the edges of the sheet section (e.g. all four edges).

FIG. 7 shows an example urine-absorbing sheet section 700 having slits 702 and an adhesive backing 704. The slits 702 run partially down a width of the urine-absorbing sheet section 700 from the outer edges, and form foldable regions, such as foldable region 706, on an outer edge of the sheet section 700. The adhesive backing 704 is also on or adjacent to an outer edge of the sheet section 700, allowing the foldable region 706 to be folded down over an object and onto the sheet itself to adhere the foldable region 706 down, for example. Additionally, when the sheet section 700 is positioned vertically, such as on a wall, foldable regions along the sheet section 700 may also fold down onto the floor and adhere to the floor, which may prevent leakage onto the floor. As another example, when the sheet section 700 is positioned on the floor, foldable regions along the sheet section 700 may fold up and adhere onto a side wall.

FIG. 8 shows an example manner in which the foldable region 706 may be folded over the metal bar of a cage wall 800 back onto itself, allowing the sheet section 700 to be attached to the cage wall 800. Multiple folded regions may be folded over the cage wiring and adhered to the sheet section 700 to keep the sheet section 700 up on the cage wall 800. In other examples, an adhesive backing may cover a greater portion of the backside of the urine-absorbing sheet. The adhesive backing 704 may be configured to adhere to one or more of dry wall, wood, metal, and/or the sheet itself. The adhesive backing 704 may not adhere to the sheet itself when arranged in a layered configuration, as to allow each sheet section in a continuous sheet to be easily dispensed. As examples, the adhesive may be a pressure-sensitive adhesive, or the adhesive backing 704 may include a release liner that is removable. The adhesive backing may allow the urine-absorbing sheet to stick to objects and stay in place, and to hug sides and corners of walls or kennels.

It is to be understood that the configurations described herein are exemplary in nature, and that these specific embodiments or examples are not to be considered in a limiting sense, because numerous variations are possible. The subject matter of the present disclosure includes all novel and non-obvious combinations and sub-combinations of the various devices and configurations, and other features, functions, and/or properties disclosed herein, as well as any and all equivalents thereof.

1-15. (canceled)

16. A dispensing container comprising:
an enclosure configured to house a layered arrangement of a continuous, urine-absorbing sheet that is replaceable, the enclosure comprising a base structure and a removable covering removably attached to the base structure, the base structure comprising one or more locking features configured to receive corresponding features of the removable covering, the base structure configured to enable the dispensing container to stand upright on a surface, the removable covering having
an opening in an end of the removable covering through which the layered arrangement of the continuous, urine-absorbing sheet may be inserted, and
an aperture in a side of the removable covering through which the sheet may be pulled; and
one or more support structures for mounting the container to an inside of a kennel to position the aperture in a generally vertical orientation.

17. The dispensing container of claim 16, wherein the one or more support structures comprise hooks configured to hang the dispensing container in a kennel.

18-19. (canceled)

20. The dispensing container of claim 16, wherein the enclosure comprises a rod configured to support a roll of the continuous, urine-absorbing sheet.

21. The dispensing container of claim 16, further comprising the continuous urine-absorbing sheet, wherein the continuous urine-absorbing sheet is separable into individual sheet sections, the urine-absorbing sheet being separable at predefined locations in the sheet.

22. The dispensing container of claim 21, wherein the urine-absorbing sheet comprises an absorbent layer and a liner layer.

23. The dispensing container of claim 22, wherein the absorbent layer and the liner layer are bound at least partially along the edges.

24. The dispensing container of claim 21, wherein the layered arrangement comprises a folded stack arrangement.

25. The dispensing container of claim 21, wherein the urine-absorbing sheet comprises perforations at the predefined locations.

26. The dispensing container of claim 21, further comprising an adhesive backing adjacent to an outer edge of the urine-absorbing sheet.

27. The dispensing container of claim 26, further comprising a release layer over the adhesive backing.

28. The dispensing container of claim 21, further comprising a foldable region formed in an outer edge of the sheet.

29. The dispensing container of claim 28, wherein the foldable region comprises a plurality of flaps formed by slits.

30. The dispensing container of claim 16, wherein the one or more locking features comprises one or more of a notch, a protruding structure, a latch, a magnet, a slot, and a snapping structure.

31. The dispensing container of claim 16, wherein the one or more locking features are on the base structure, and wherein the one or more locking features are configured to receive complementary features on the removable covering.

32. The dispensing container of claim 16, wherein the base structure is weighted relative to the removable covering.
